(19) United States
(12) Patent Application Publication
(10) Pub. No.: US 2009/0188520 A1
(43) Pub. Date: Jul. 30, 2009

(54) COATED DENTAL DEVICES WITH ABLATIVE ABRASIVES

(75) Inventor: Dale G. Brown, Wharton, TX (US)

Correspondence Address: BANNER & WITCOFF, LTD., 28 STATE STREET, 28th FLOOR, BOSTON, MA, 02109-9601, US

(73) Assignee: WhiteHill Oral Technologies, Inc., Stafford, TX (US)

(21) Appl. No.: 12/022,183

(22) Filed: Jan. 30, 2008

(51) Int. Cl. A61C 15/04

(52) U.S. Cl. 132/321

(57) ABSTRACT

Dental devices coated with substantially aqueous-free, saliva soluble, base coatings and ablative abrasives that break down during flossing; which combination creates the perception during flossing that said devices are working.

### FIELD OF THE INVENTION

The present invention is directed to dental devices coated with substantially aqueous-free, saliva soluble, base coatings and ablative abrasives that break down during flossing. This combination creates the user perceivable signal of cleaning efficacy during flossing. Specifically these coated dental devices are perceived as working.

### BACKGROUND OF THE INVENTION

Dental floss is defined in Webster's New World Dictionary, 1983, as . . . thread for removing food particles between the teeth.

The concept of using dental floss for cleansing interproximal spaces appears to have been introduced by Parmly in 1819, Practical Guide to the Management of Teeth, Cullins & Croft Philadelphia, Pa. Numerous types of floss were developed and used for cleaning interproximal and subgingival surfaces, until finally in 1948 Bass established the optimum characteristics of dental floss, Dental Items of Interest, 70, 921-34 (1948).

Bass cautioned that dental floss treated with sizing, binders and/or wax produces a cord effect as distinguished from the desired spread filament effect. This cord effect reduces the perception of flossing efficiency dramatically and visually eliminates splaying (i.e., the flattening and spreading out of filaments) necessary to achieve the required interproximal and subgingival mechanical cleaning. This cleaning is then required to be followed by the entrapment and removal of debris, plaque and microscopic materials from interproximal spaces by the spread floss as it is removed from between teeth.

Proper use of dental floss is necessary to clean the considerable surface area on the interproximal surfaces of teeth, which cannot usually be reached by other cleaning methods or agents, e.g., the bristles of a toothbrush, the swishing action of a rinse, or by the pulsating stream from an oral irrigator. It is estimated that the 15% of interproximal tooth surfaces are responsible for about 85% of gum disease.

Historically, the purpose of dental floss was to:
(1) dislodge and remove any decomposing food material, debris, etc., that had accumulated at the interproximal surfaces, which could not be removed by other oral hygiene means; and
(2) dislodge and remove as much as possible the growth of bacterial material—plaque (biofilm), tartar and calculus—that had accumulated there since the previous cleaning.

Effective oral hygiene requires that three control elements be maintained by the individual:
(1) Physical removal of stains, plaque (biofilms) and tartar. This is accomplished in the strongest sense by scraping and abrasion in the dentist's office (prophylaxis). Self administered procedures are required frequently between visits and range from tooth brushing with an appropriate, abrasive toothpaste through flossing and water jet action down to certain abrasive foods and even the action of tongue against tooth surfaces.
(2) Surfactant Cleaning. This is required to remove: food debris and staining substances before they adhere to the tooth surface; normal dead cellular (epithelial) material which is continually sloughed off from the surfaces of the oral cavity and microbial degradation products derived from all of the above. Besides the obvious hygienic and health benefits related to simple cleanliness provided by surfactants, there is an important cosmetic and sense-of-well-being benefit provided by surfactant cleaning. Research has shown that the primary source of bad breath is the retention and subsequent degradation of dead cellular material sloughed off continuously by the normal, healthy mouth.
(3) Frequency of Cleaning. This is perhaps the most difficult to provide in today's fast-paced work and social environment. Most people recognize that their teeth should be brushed at least 3 times a day and flossed at least once a day. The simple fact is that most of the population brush once a day, some brush morning and evening, but precious few carry toothbrush and dentifrice to use the other three or four times a day for optimal oral hygiene. Consumer research suggests that the population brushes an average of 1.3 times a day. Most surprising, only about 12% of adults floss regularly. Reasons offered for not flossing: difficult to do, painful, not effective, doesn't seem to do anything, and leaves a bad taste.

Many commercial interproximal devices marketed at the present time contain various coatings of wax or wax like substances that function as: binders for the various multifilament flosses to minimize fraying, lubricants, flavor carriers, and/or fluoride carriers. When added to various monofilament dental tapes, generally at substantially lower levels, wax functions as a lubricant and/or flavor/active ingredient carrier.

An almost universal shortcoming common to most coated dental flosses and to all coated monofilament dental tapes is the user perception during flossing that the dental floss or dental tape is not working and/or not cleaning, etc. This complaint is generally associated with most PTFE dental tapes.

### SUMMARY OF THE INVENTION

This invention relates to coated interproximal dental devices containing ablative abrasives, which provide a user-perceivable signal of cleaning efficacy, or an it's working perception during use. This mouthfeel perception, described as crunchy by the user is advantageous as it sends an extra signal to the user during flossing that the dental device is doing more than ordinary dental devices. The crunchy perception is preceded by a gritty tactile perception perceived while winding the dental device around fingers in preparation for flossing. These it's working perceptions are key motivators in encouraging traditional non-flossers to floss regularly.

The ablative abrasive remains substantive to the base coating, until the saliva soluble, base coating is released during flossing. Prior to flossing, the ablative abrasive delivers a tactile gritty perception as the dental device is wound around the fingers. During flossing, the ablative abrasive separates from the released base coating, delivering a crunchy mouthfeel. Shortly thereafter the ablative abrasive breaks down having establishing the perception that the floss is working.

The perception that the ablative abrasive is working is achieved when the ablative abrasive is:
(1) included in the base coating,
(2) overcoated onto the base coating, and/or
(3) included in the base coating and overcoated onto the base coating.

This it's working perception is attributed to two motivational triggers:
(1) the tactile grittiness of the ablative abrasive, which is perceived while winding the device around the forefingers. This perception is most pronounced when the ablative abrasive is present as an overcoating, and/or
(2) the crunchiness perceived during flossing, when the ablative abrasive is released into the oral cavity, prior to its breaking down in the saliva. The time interval between release of the ablative abrasive from the dental device and the breaking down of the released ablative abrasive is from between about 5 and about 45 seconds.

Accordingly, one embodiment of the present invention comprises coated dental devices containing ablative abrasives that create the perception during flossing that the device is working.

A further embodiment of the present invention comprises coated dental devices containing ablative abrasives that, during winding of the dental device around fingers in preparation for flossing, deliver the tactile sensation of grittiness.

Another embodiment of the present invention comprises coated dental devices containing ablative, abrasives that, during flossing, deliver a crunchy perception to the oral cavity prior to breaking down.

Still another embodiment of the invention comprises a coated dental device containing ablative, abrasives that motivates non-flossers to floss regularly, driven by the perception that the device is working.

Additional embodiments include:
A coated dental device comprising a substantially aqueous-free, saliva soluble, base coating and an ablative abrasive that breaks down, both of which are released into the oral cavity during flossing, creating a perception that the dental device is working.

Especially preferred aspects of this embodiment include the following:
where the dental device is selected from the group of dental devices consisting of multifilament, monofilament and combinations thereof,
where the monofilament dental device is comprised of polymers selected from the group consisting of polytetrafluoroethylene, polyethylene, polypropylene, PEBA, TPE, TPE-E, copolymer bicomponent and mixtures thereof,
where the multifilament dental device is comprised of filaments selected from the group of filaments consisting of nylon, polypropylene, polyester and combinations thereof;
where the ablative abrasive is selected from the group of ablative abrasives consisting of bicarbonates, phosphosilicates, pyrophosphates, hexametaphosphates, silicates and mixtures thereof,
where the ablative abrasive is included in said saliva soluble, base coating. where the ablative abrasive is present as an overcoating on said saliva soluble, base coating;
where the ablative abrasive is present in said saliva soluble, base coating and as an overcoating on said saliva soluble, base coating;
where the ablative abrasive is calcium sodium phosphosilicate;
where the calcium sodium phosphosilicate is comprised of: 45% SiO₂, 24.5% Na₂O, 24.5% CaO and 6% P₂O₃;
where the ablative abrasive is present at between about 0.25% and about 30% by weight of the dental device;
where the working perception is attributed to the tactile grittiness perceived while winding the device on fingers in preparation for flossing;
where the working perception is attributed to said ablative abrasive crunchiness perceived during flossing;
where the ablative abrasive has a working time between about 5 and about 45 seconds;
where the ablative abrasive has a PWF of at least about 1;
where the ablative abrasive has an IRF of at least about 70%;
where the ablative abrasive has an RDA between about 80 and about 200;
where the ablative abrasive, when exposed to saliva, breaks down;
where the ablative abrasive, when exposed to saliva, dissolves;
where the ablative abrasive, when exposed to saliva, ionizes; and
where the ablative abrasive is comprised of granules of at least about 37 microns, wherein said granules are constituted from aggregate particles of water soluble materials below about 37 microns in mean diameter and are perceived as crunchy during flossing;

### Definitions of Key Terms

Dental devices coated with substantially aqueous-free, saliva soluble, base coatings and ablative abrasives that break down during flossing; which combination creates the perception during flossing that said devices are working. For purposes of describing the present invention, the following terms are defined as set out below:

Dental devices are defined as interproximal dental devices suitable for flossing, including monofilament and multifilament dental devices. Dental devices with various abrasives are disclosed in the following U.S. Pat. Nos. 6,575,176; 3,491,776; 3,699,979; 4,795,421; 5,165,913; 6,027,592; 6,039,054; 6,453,912; 7,017,591; and 7,152,611, the disclosures of which are hereby incorporated by reference.

Monofilament dental devices are defined as interproximal dental devices such as monofilament dental tape constructed of a single continuous polymeric monofilament, which can be extruded, slit from a film, etc. Examples of these devices are described in the following U.S. patents:

Re. 35,439; 3,800,812; 4,974,615; 5,760,117; 5,433,226; 5,479,952; 5,503,842; 5,755,243; 5,845,652; 5,884,639; 5,918,609; 5,962,572; 5,998,431; 6,003,525; 6,083,208; 6,198,830; 6,161,555; 6,027,192; 5,209,251; 5,033,488; 5,518,012; 5,911,228; 5,229,932; 4,776,358; 5,718,251; 5,848,600; 5,787,758; and 5,765,576; the disclosure of which hare hereby incorporated by reference.

Preferred polymeric monofilament dental devices include polytetrafluoroethylene (PTFE), polyethylene, polypropylene, etc., devices. Polytetrafluoroethylene (PTFE) based interproximal devices are described in: U.S. Pat. Nos. 5,209,251; 5,033,488; 5,518,012; 5,911,228; 5,220,932; 4,776,358; 5,718,251; 5,848,758; and 5,765,576. Monofilament dental tapes, in general, feature extraordinary shred resistance compared to multifilament dental flosses including those multifilament flosses described in the Hill, et al., U.S. Pat. Nos. 4,911,927; 5,057,927; 5,057,310; 5,098,711; 5,165,913; and 5,711,935. The disclosures of all of the foregoing are hereby incorporated by reference. Multifilament dental devices are defined as interproximal devices constructed of multiple filaments such as described in the following U.S. patents, which are hereby incorporated by reference:

U.S. Pat. Nos. 4,911,927; 4,029,113; 4,610,872; 4,034,771; 5,908,039; 2,667,443; 3,830,246; 1,149,376; 1,069,874; 5,830,495; 2,748,781; 1,138,479; 1,839,486; 1,943,856; 6,080,481; 2,700,636; 3,699,979; 3,744,499; 3,837,351; 4,414,990; 3,330,732; 5,967,155; 5,937,874; 5,505,216; 5,503,842; 5,032,387; 4,950,479; 5,098,711; 1,989,895; 5,033,488; 2,542,518; 2,554,464; 1,285,988; 1,839,483; 4,151,851; 2,224,489; 2,464,755; 2,381,142; 3,800,812; 3,830,246; 3,897,795; 3,897,796; 4,215,478; 4,033,365; 3,771,536; 3,943,949; 6,016,816; 6,026,829; 5,353,820; 5,557,900; 5,226,435; 5,573,850; 5,560,377; 5,526,831; 5,423,337; 5,220,932; 4,548,219; 3,838,702; 5,904,152; 4,911,927; 5,711,935; 5,165,913; and 5,098,711.

Preferred multifilament dental devices include nylon, polyethylene, polypropylene, polyester, etc., flosses, including twisted, entangled, untwisted, untangled, texturized and versions thereof. Particularly preferred multifilament dental devices include various coated multifilament dental flosses as well as those described and claimed in U.S. Pat. Nos. 4,911,927; 5,098,711; 5,165,913; and 5,711,935.

The terms fiber and filament are used synonymously throughout this specification in a manner consistent with the first three definitions of fiber and the first definition of filament as given in the New Illustrated Webster's Dictionary, @ 1992 by J. G. Ferguson Publishing Co. the relevant disclosure of which is hereby incorporated herein by reference.

The strength of the filaments may be expressed in terms of tenacity, defined as the force required to break the filaments, i.e., breaking force (in grams) divided by the filament basis weight (in denier). To prevent the floss filaments from breaking during use, the filaments generally have a tenacity of at least about 3 grams/denier, preferably at least about 5 grams/denier, and more preferably, at least about 7 grams/denier. Filaments which satisfy this tenacity requirement and which may be used in the multifilament floss of the invention include the polyamides, for example, nylon-6 and nylon-6,6; polyolefins, for example polypropylene and polyethylene; and polyesters such as polyethylene terephthalate and various natural products including cotton and silk.

The multifilament flosses of the invention are supple, by which we mean that they are soft, flexible and pliant. A supple multifilament floss is one which is gentle on the gums and hands, easy to hold, and slides easily between teeth because it complies to the curvature of tooth surfaces in order to fit between tight surfaces between the teeth. The factors that affect suppleness include filament basis weight (related to filament diameter), degree of twist, degree of entanglement and the elastic modulus of the material from which the yarn is made. As used herein, the term basis weight as used to describe filaments, yarns and flosses refers to the weight of the article (in grams) of 9000 meters of the article. The weight in grams of 9000 meters is sometimes referred to as denier. For a given multifilament yearn, as the filament diameter decreases for a multifilament yearn of a given basis weight, the floss will be able to pass through tight spaces more easily because the individual filaments slide past each other. For example, a first floss may be comprised of a 630 denier, each filament having a basis weight of 6 denier. This yarn comprises 105 filaments. A second multifilament floss may be comprised of a second yarn also having a basis weight of 630 denier, each filament having a basis weight of 3 denier. This second yarn comprises 210 filaments. While both yarns have the same overall basis weight, multifilament floss made from the second yarn will pass more easily between the teeth because the smaller diameter filaments slide more easily past each other. Also, the smaller the filament diameter, the lower will be the bending modulus per filament and the bending modulus for the yarn as a whole, thereby making the multifilament floss softer and more flexible. As the degree of twist and/or entanglement of the yarn increases, the resulting multifilament floss becomes less supple because the filaments are unable to slide as the floss is inserted into tight interproximal spaces.

A measure of the fineness of the yarn comprising the multifilament flosses of the invention is the yarn basis weight. The yarn basis weight (expressed in denier) affects such properties as the ease of passing between teeth, perception of cleaning between teeth, strength, and gentleness of the multifilament floss on the gums. As the overall basis weight of the yarn decreases, the multifilament floss will pass more easily between teeth. However, decreasing the basis weight below an acceptable value will decrease the floss strength, reduce the perception of cleaning between teeth and will be harsher on the gums. To balance these properties, the multifilament flosses of the present invention preferably comprises a yarn having a basis weight of between about 500 and about 1200 denier. More preferably, the yarn should have a basis weight between about 550 and 850 denier, and most preferably, between about 550 and about 700 denier.

The multifilament dental flosses used in the present invention preferably comprise:
A bundle of multi-fiber dental floss wherein:
   the multi-fiber dental floss:
   contains from between 2 and 12 bundles,
   has a denier between about 300 and about 1,200, and
   contains between about 100 and about 800 filaments; the fibers include natural and/or man made fibers and mixtures thereof, including filament bundles with tackings throughout, twisted continuous filament bundles and texturized multifilament bundles, each of which can be comprised of nylon, polyester, polypropylene, cotton, silk, etc., and blends thereof, and
Bundles of multi-fiber dental floss, as described above, with specific functionality such as adsorption wherein:
the multi-fiber, multi-composition dental floss:
contain 1-6 bundles of the specific functionality fibers,
has a specific functionality fiber denier between 50 and 500, which contains between about 20 to 400 filaments.

Preferably the multi-composition portion of the multi-fiber dental floss includes:
swellable fibers such as used in disposable diapers,
saliva or water soluble fibers containing additional chemotherapeutic preparations,
hollow membrane transport fibers such as are used in dialysis systems,
microporous fibers such as Accurel® fibers by AKZO Chemie constructed from polyethylene or polypropylene,
fibers rendered essentially microporous by the incorporation of micron-sized particles of agents such as calcium chloride, silica gel, activated charcoal and the like.
fibers capable of withdrawing water or specific fluids by incorporating micron-sized particles of agents such as calcium chloride, silica gel, activated charcoal and the like.

In a preferred embodiment of the present invention the multifilament dental floss used is nylon which contains between 4 and 8 bundles with a denier between about 500 and about 1,000 and contains between about 200 and 600 filaments, with or without texturizing. In a particularly preferred embodiment of the present invention the dental floss used is nylon containing 6 bundles and has a denier of about 840 with approximately 408 filaments.

Coatings for the dental devices of the present invention are defined as those substantially aqueous-free substances that coat dental devices for purposes of: lubrication and ease of tape insertion, for carrying flavors and other additives, providing hand so the device can be wound around the fingers, etc. Preferred coatings include those saliva soluble emulsion coatings including MICRODENT®-containing coatings described and claimed in the following U.S. Pat. Nos. 4,950,479; 5,032,387; 5,538,667; 5,561,959; and 5,665,374, which are hereby incorporated by reference.

Particularly preferred coatings include those saliva soluble, substantially aqueous-free emulsion coatings for dental tapes including ULTRAMULSION®-containing coating described and claimed in U.S. Pat. Nos. 6,545,077; 6,575,176; 6,604,534; 6,609,527; 6,884,309; 6,907,889; 6,916,880; and 7,017,591, which are hereby incorporated by reference. Particularly preferred coatings are crystal-free coatings.

Ablative abrasives are defined as saliva-responsive abrasives of various particle sizes which dissolve, change, ionize, and break down, etc. when exposed to saliva. The particle sizes range from between about 1 micron and 200 microns. These ablative abrasives have acceptable RDA values and are generally used at concentrations from between about 5% by weight and about 30% by weight of the dental device. Ablative abrasives are characterized as follows:
(1) when wrapping the coated dental device around the fingers, prior to flossing, they impart a tactile gritty response, and/or
(2) when released into saliva during flossing, prior to breaking down, they impart a crunchy perception that the dental device is working.

Key to the it's working feature of the dental devices of the present invention, is that the saliva soluble base coating on the device remains substantially aqueous-free, thereby avoiding compromising the ablative properties of the abrasive prior to flossing. Preferred saliva soluble base coatings suitable for use with the ablative abrasives are aqueous-free and readily dissolve in saliva and are therefore substantially totally released from the dental device substrate during flossing.

Ablative abrasives suitable for the devices of the present invention include: bioglasses, sodium bicarbonate, tetrasodium pyrophosphate, sodium hexametaphosphate and sodium tripolyphosphate. In addition, other ablative abrasives suitable for the present invention include ablative abrasive granules greater than 27 microns constituted from particles of water soluble materials that are below 37 microns in mean diameter. These small particles are aggregated to form larger particles which are perceived as crunchy when of greater than 37 microns. Break up of small particles is facilitated by the crushing action of the teeth.

Preferred ablative abrasives of the invention include: bioglasses such as calcium sodium phosphosilicates in particle sizes ranging from between about 1 and about 200 microns. Particularly preferred calcium sodium phosphosilicates include bioactive, ionic compositions containing 45% SiO₂, 24.5% NaO, 24.5% CaO and 6% P₂O₃. These are available from NovaMin Technology, Inc., Alachúa, Fla., under the trademark NovaMin®. These calcium sodium phosphosilicates, when exposed to saliva, respond by releasing mineral ions which results in the particles breaking down. See the following relevant references discussing calcium sodium phosphosilicates:
Gillette, Robert L., DVM, MSE; Steven F. Swaim, DVM, MS; Eva A, Sartin, DVM, PhD; Dino M. Bradley, DVM, PhD; Shindok L. Coolman, MS. 2001. Effects of a Bioactive Glass on Healing of Closed Skin Wounds in Dogs. AJVR, 62(7): 1149-1153.
Tai, Bao Jun, Zhuan Bian, Han Jiang, David C. Greenspan, Jipin Zhong, Arthur E. Clark and Min Quan Du. 2006. Anti-gingivitis Effect of a Dentifrice containing Bioactive Glass (NovaMin®) particulate. J Clin. Periodontology, 33: 86-91. Seidel-Bittke, Debra, RDH, BS. 2005. Novel NovaMin. RDH, August 2005.
Lee, S., J. Zimmer, J. Fechner, G. E. Uzunian, L. Song. 2003. Bioactive Glasses: A Potential New Class of Active Ingredients for Personal Care Products. SOFW-Journal, 129. Jahrgang 9-2003

The ablative abrasives of the invention are added to the dental device by means of substantially aqueous-free coatings at between about 0.25% and about 30% by weight of the dental device. Particularly preferred levels of ablative abrasive are between about 3% by weight and 15% by weight of the device. A preferred method of adding the ablative abrasive to the coated device by means of a dusting process where the device is passed through a chamber charged with ablative abrasive particles in the air, wherein the abrasive particles overcoat the coated device as it passes through the dusting chamber.

Ablative abrasive working time is defined as the property whereby ablative abrasive, which is substantive to the base coating of the dental device, remains substantive to said base coating until flossing begins, at which time the ablative abrasive separates from the saliva soluble base coating and remains available interproximally and subgingivally for a sufficiently long interval to register it's working with its crunchiness. Such it's working intervals generally range from between 5 and 45 seconds.

Ablative abrasive load is defined as the percent by weight of ablative abrasive contained on the coated dental device as a percent by weight of the coated dental device.

Base coat dental device load is defined as the percent by weight of the base coating contained on the dental device as a percent by weigh to the coated dental device.

Total coating load is defined as the percent by weight of the base coating plus the ablative abrasive coating contained on the dental device as a percent by weight of the coated dental device.

Perceived work factor (PWF) is defined as the user's subjective level of perceived ablative abrasivity when:
(1) winding the coated dental device around the fingers (i.e., grittiness), and
(2) when working the device across tooth surfaces with a sawing action (i.e., crunchiness).

PWF values range from 0 through 4, i.e., imperceptible (0), slightly perceptible (1), perceptible (2), very perceptible (3), and most perceptible (4). PWF values of about 1 or greater are preferred. PWF values above 2 are particularly preferred. While different users may have different perceptions regarding the use of this product, each individual user has the ability to readily determine whether the device has a PWF value of 0 through 4, making this subjective test relevant as a descriptive aid herein.

Incidental Release Factor (IRF) is defined as the percent by weight of the ablative abrasive retained on the coated monofilament dental device, after an 18 inch piece of the device is removed from a dispenser and wrapped around two fingers prior to flossing. IRF values of at least about 70% are preferred.

Fluidized bed is defined as a means of converting solid particulate abrasives into an expanded, suspended, solvent-free mass that has many properties of a liquid. This mass of suspended particulate abrasive has zero angle of repose, seeks its own level, while assuming the shape of the containing vessel.

### BRIEF DESCRIPTION OF THE DRAWINGS

FIG. 1 is a schematic side view of an ablative abrasive overcoating over a saliva soluble base coating on a monofilament dental tape.

FIG. 2 is a schematic side view of a coated multifilament dental device, where the saliva soluble base coating also contains an ablative abrasive.

FIG. 3 is a schematic side view of a coated monofilament dental tape, where the saliva soluble base coating contains ablative abrasive and the base coating has an overcoating of ablative abrasive.

### DETAILED DESCRIPTION OF THE PREFERRED EMBODIMENTS

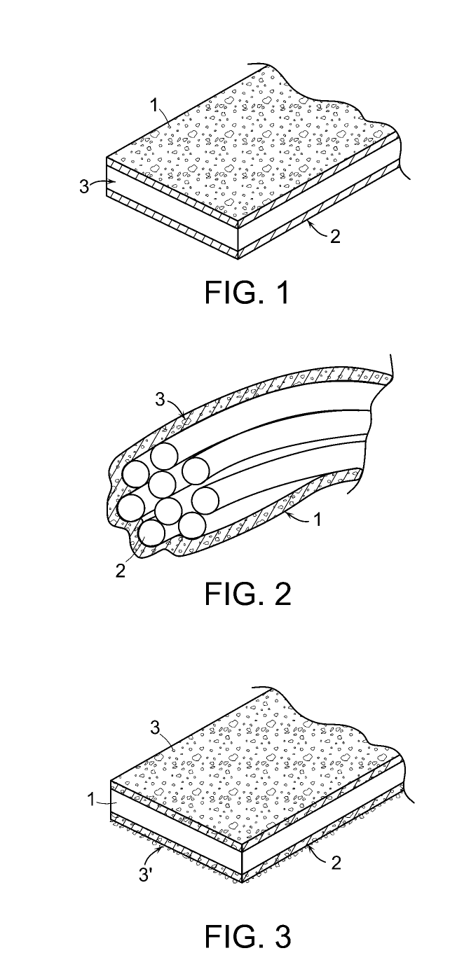

Referring to FIG. 1, which is a schematic side view of an ablative abrasive, overcoating, 1, over a saliva soluble base coating, 2, on monofilament dental tape, 3. During flossing, base coating, 2 and ablative abrasive, 1, are released from dental tape, 3, into saliva in the oral cavity. Ablative abrasive, 1, breaks down after registering the crunchy perception during flossing that it is working.

Referring to FIG. 2, which is a schematic side view of a saliva soluble base coating, 1, on multifilament dental device, 2. Saliva soluble coating, 1, contains ablative abrasive, 3. During flossing, saliva soluble coating, 1, and ablative abrasive, 3, are released from multifilament device, 2, into the oral cavity, where ablative abrasives, 3, register it is working before it breaks down.

Referring to FIG. 3, which is a schematic side view of a coated monofilament dental tape, 1, where saliva soluble base coating, 2, contains ablative abrasive, 3, and is overcoated with ablative abrasive, 3′. While winding the tape around fingers prior to flossing, ablative abrasive, 3′, registers a tactile gritty perception.

During flossing, both ablative abrasives, 3 and 3′ are released from dental tape, 1, with saliva soluble base coating, 2.

Key to the present invention is that the ablative abrasive has a suitable RDA number. The grittiness and crunchiness of the ablative abrasive are key to imparting the it's working perception. The saliva-responsive properties of the ablative abrasive, combined with the suitable RDA value for the ablative abrasive of the present invention, assures that the ablative abrasive does not injure the hydroxyapatite and/or the soft tissue contacted during flossing.

The cleaning performance of various abrasives is well documented by using conventional abrasion and cleaning tests. For example, dentifrice compositions are typically screened in vitro using the Stookey Cleaning Test to determine a composition's efficacy for cleaning and stain removal. This test performs a simulated brushing action typically on more readily available bovine teeth which have been artificially stained. The removal of stain after a brushing operation is quantified by measuring the decrease in color (or blackness) using a calorimeter. Rather than comparing absolute changes in color, the data are usually referenced to that of American Dental Association reference material calcium pyrophosphate (that is, the stain reduction resulting from calcium pyrophosphate use is taken to be by definition 100). Therefore, the cleaning performance of the test compositions will be either below (<100), equal to =100), or higher (>100) than that obtained using calcium pyrophosphate. This normalized cleaning value is often called the Pellicle Cleaning Ratio (PCR). The higher the PCR the greater the stain removal or whitening.

Radioactive Dentin Abrasion (RDA) testing measures how the abrasive nature of the dentifrice composition contributes to removal of the softer dentin tissue of the tooth structure. In this test, irradiated dentin is brushed in a manner similar to that described above for cleaning. The amount of dentin that is abraded away from the brushed structure is quantified via radioactive analysis of ³²P which is observed in the abrasive slurry. In a manner similar to that described for cleaning, the amount of dentin abrasion is referenced for cleaning, the amount of dentin abrasion is referenced to that which occurs with calcium pyrophosphate which is likewise set at 100. The lower the RDA, the less abrasive the dentifrice composition. The RDA of the saliva soluble coating compositions containing the ablative abrasive are generally between about 100 and 200.

Radioactive Enamel Abrasion (REA) testing is analogous to RDA testing. The abrasive effect on the enamel which is a harder tissue than dentin is quantified in a likewise manner. In this test irradiated enamel is brushed in a manner similar to that described above for cleaning. The amount of enamel that is abraded away from the brushed structure is quantified via radioactive analysis of ³²P which is observed in the abrasive slurry. In a manner similar to that described for cleaning, the amount of enamel abrasion is referenced to that which occurs with calcium pyrophosphate. At least two commercial sources, e.g., Indiana University (IU) and Missouri Analytical Laboratories (MAL) perform this test and reference the test data to that of calcium pyrophosphate. However, they set different values for calcium pyrophosphate. IU normalizes to 10 whereas MAL normalizes to 100. The data described herein are supplied by Indiana University. The lower the REA value, the less abrasive the dentifrice composition. The ablative abrasives of the present invention have suitable REA values.

Overcoating coated multifilament floss and monofilament dental tape with ablative abrasives can be carried out by imparting a static charge to the ablative abrasive prior to discharge from the nozzle means. Means are provided for grounding the liquid, base, coated multifilament or monofilament in order to receive the charged ablative abrasive. Alternatively, ablative abrasives can be imbedded into liquid base coatings on multifilament dental flosses and monofilament dental tapes by various spraying means.

In addition to various types of fluidized bed/nozzle arrangements, the ablative abrasive overcoatings can be imbedded into the coated multifilament dental flosses or onto coated monofilament dental tapes by several other means for impinging abrasives particulates onto liquid coated devices. These include various powder coating processes including fluidized bed, plastic frame spraying, electrostatic spraying and sonic spraying. In the latter, sound waves are used to suspend the ablative abrasives before introducing the fluidized abrasive into a nozzle means. Other particulate abrasive overcoating processes are described in U.S. Pat. Nos. 6,037,019; 3,848,363; 3,892,908; 4,024,295; 4,612,242; 5,163,975; 5,232,775; 5,273,782; 5,389,434; 5,658,510; 2,640,002; 3,093,501; 2,689,808; 2,640,001 and 5,194,297. These can be adapted to ablative abrasive impingement on coated dental devices as taught by the present invention and are incorporated herein by reference.

Particularly preferred ablative abrasive overcoating means include various Nordson® automatic powder coating systems such as the Nordson® Tribomatic II powder coating system, which includes various Nordson® powder pumps, as well as ITW Gema Powder coating systems including their Easysystem™ and Electrostatic Equipment Co's 7R FLEXICOAT® system.

The ablative overcoating of the invention can be affected with various other means for delivering abrasive to the liquid base coating. For example, the abrasive can be introduced by a simple screening technique where the abrasive drops from the screening means onto the liquid base-coated multifilament or monofilament device.

The preferred means of the invention for overcoating includes a fluidized bed in combination with a nozzle means. This combination provided the most uniform overcoatings while controlling the extent of the ablative abrasive imbedding into the liquid base coating.

### EXAMPLES

The invention is further described and illustrated in the following examples:

### Example 1

Ultrahigh molecular weight polyethylene (UHMWPE) tape of 1.1 mil thick and 62 mils wide was compression coated with a water soluble coating consisting of poloxamer 338, 44.7%; polydimethylsiloxane 2.5 million CS, 4.6%; propyl gallate, 0.1%; EDTA, 0.2%; flavor, 5.6%; dicalcium phosphate dihydrate, 6%, PEG 8000, 11.4%, Microcrystalline wax, 7%; stearyl alcohol, 15%; Pluracare L-1220, 3%, sodium saccharin, 2.4%. As the tape was coated with the molten formulation at 90° C. at a level of 67 mg/yd, a particulate overcoating of calcium sodium phosphosilicate, 70 micron average particle size, was applied according to the method of U.S. Pat. No. 7,017,591 to give 27 mg/yd of calcium sodium phosphosilicate. The dental tape thus produced exhibited a gritty, tactile perception while winding the tape on fingers followed by a gritty perception between the teeth when flossing. The crunchy perception in the mouth rapidly disappeared within 19 seconds as the overcoated abrasive broke down in response to saliva.

### Example 2

A dental tape composed of HDPE monofilament of 530 denier was compression coated with a saliva soluble coating consisting of poloxamer 338, 44.7%; polydimethylsiloxane 1000 CS, 4.6%; propyl gallate, 0.1%; EDTA, 0.2%; flavor, 5.6%; dicalcium phosphate dihydrate, 6%, PEG 8000, 11.4%, Microcrystalline wax, 7%; stearyl alcohol, 15%; Pluracare L-1220, 3%, sodium saccharin, 2.4%. As the tape was coated with the molten formulation at 90° C. at a level of 65 mg/yd, a particulate overcoating of calcium sodium phosphosilicate, 70 micron average particle size, was applied according to the method of U.S. Pat. No. 7,017,591 to give 14 mg/yd of calcium sodium phosphosilicate. The dental tape thus produced exhibited a gritty, tactile perception while winding the tape on fingers followed by a gritty perception between the teeth when flossing. The crunchy perception in the mouth rapidly disappeared within 17 seconds as the overcoated abrasive broke down in response to saliva.

### Example 3

A dental floss composed of 272 nylon 6,6 filaments of 840 denier was compression coated with a saliva soluble coating consisting of poloxamer 407, 42.6%; Dow Corning AF-1500, 10%; Carbowax 1450, 8.0%; Calcium Sodium phosphosilicate, 26.6%; propyl gallate, 0.1%; flavor, 6.4%; silica, 4%, sodium saccharin, 2.3%. The floss was coated with the molten formulation at 90° C. at a level of 91 mg/yd. The dental floss thus produced exhibited a gritty, tactile perception while winding the floss on fingers followed by a gritty perception between the teeth when flossing. The crunchy perception in the mouth disappeared within 20 seconds as the abrasive in the coating broke down in response to saliva.

### Example 4

A monofilament dental tape composed of 1093 denier PTFE was compression coated with a saliva soluble coating consisting of poloxamer 338, 44.7%; polydimethylsiloxane 1000 CS, 4.6%; propyl gallate, 0.1%; EDTA, 0.2%; flavor, 5.6%; dicalcium phosphate dihydrate, 6%, PEG 8000, 11.4%, Microcrystalline wax, 7%; stearyl alcohol, 15%; Pluracare L-1220, 3%, sodium saccharin, 2.4%. As the tape was coated with the molten formulation at 90° C. at a level of 98 mg/yd, a particulate overcoating, calcium sodium phosphosilciate, 62 micron average particle size, was applied according to the method of U.S. Pat. No. 7,017,591 to give 18 mg/yd of calcium sodium phosphosilicate. The dental tape thus produced exhibited a gritty, tactile perception while winding the tape on fingers followed by a gritty perception between the teeth when flossing. The crunchy perception in the mouth rapidly disappeared within 17 seconds as the overcoated abrasive dissolved in the saliva.

The invention is further described by illustrative examples 5 through 12, as detailed in Tables 1 and 2 below:

TABLE 1
Monofilament Devices
Examples 5-8

| | Example # | | | |
|---|---|---|---|---|
| | 5 | 6 | 7 | 8 |
| Type of substrate | UHMWPE | Fibaclean | PTFE | HDPE |
| | Tape | Tape | Tape | Tape |
| Composition of base | Poloxamer/ | Poloxamer/ | Poloxamer/ | Poloxamer/ |
| coating | Silicone | Silicone | Silicone | Silicone |
| (Base coat dental device | Emulsion | Emulsion | Emulsion | Emulsion |
| load) | (58) | (51) | (70) | (42) |
| Ablative abrasive | Calcium | Tetrasodium | Sodium | Sodium |
| overcoating (% by wt)/ | Sodium | pyrophosphate | hexametaphosphate | Bicarbonate |
| Particle size [in micron] | Phosphosilicate | (23) [55] | (20) [62] | (26) [45] |
| | (26) [70] | | | |
| Water present in base | >0.1 | >0.1 | >0.1 | >0.1 |
| coating (% by wt) | | | | |
| Total coating load | 78 | 66 | 88 | 57 |
| (mg/yd) | | | | |
| Percent of base coating | 78 | 75 | 78 | 77 |
| released from substrate | | | | |
| during flossing in % | | | | |
| Ablative abrasive working | 19 | 14 | 15 | 9 |
| time (in seconds) | | | | |
| Perceived Work Factor | 4 | 2 | 1 | 1 |
| (PWF) | | | | |
| Incidental Release Factor | 74 | 78 | 75 | 71 |
| (IRF) in % | | | | |

TABLE 2
Multifilament Devices
Examples 9-12

| | Example # | | | |
|---|---|---|---|---|
| | 9 | 10 | 11 | 12 |
| Type of substrate | Nylon 6,6 | Polypropylene | Nylon 6 twisted flat | Nylon 6,6 |
| | Texturized | twisted yarn | yarn | twisted |
| | twisted yarn | | | Flat yarn |
| Composition of base | Poloxamer/ | Poloxamer/ | Poloxamer/silicone | Poloxamer/ |
| coating | silicone | silicone | emulsion | silicone |
| (Base coat dental | emulsion | emulsion | (48) | emulsion |
| device load mg/yd) | (92) | (58) | | (52) |
| Ablative abrasive | Calcium | Tetrasodium | Sodium | Sodium |
| overcoating (% by wt)/ | sodium | pyrophosphate | hexametaphosphate | bicarbonate |
| Particle size | phosphosilicate | (8%) [46] | (6%) [56] | (6%) [38] |
| [in micron] | (10%) [70] | | | |
| Water present in base | >0.1 | >0.1 | >0.1 | >0.1 |
| coating (% by wt) | | | | |
| Total coating load | 54.5 | 50 | 48 | 54 |
| (mg/yd) | | | | |
| Percent of base coating | 57 | 46 | 45 | 40 |
| released from substrate | | | | |
| during flossing in % | | | | |
| Ablative abrasive | 26 | 15 | 10 | 8 |
| working time | | | | |
| (in seconds) | | | | |
| Perceived Work Factor | 4 | 2 | 2 | 1 |
| (PWF) | | | | |
| Incidental Release | 71 | 75 | 74 | 70 |
| Factor (IRF) in % | | | | |

What is claimed is:

1. A coated dental device comprising a substantially aqueous-free, saliva soluble, base coating and an ablative abrasive that breaks down, both of which are released into the oral cavity during flossing, creating a perception that the dental device is working.

2. A coated dental device of claim 1, wherein said dental device is selected from the group of dental devices consisting of multifilament, monofilament and combinations thereof.

3. A coated dental device of claim 2, wherein said monofilament dental device is comprised of polymers selected from the group consisting of polytetrafluoroethylene, polyethylene, polypropylene, PEBA, TPE, TPE-E, copolymer bicomponent and mixtures thereof.

4. A coated dental device of claim 2, wherein said multifilament dental device is comprised of filaments selected from the group of filaments consisting of nylon, polypropylene, polyester and combinations thereof.

5. A coated dental device of claim 1, wherein said ablative abrasive is selected from the group of ablative abrasives consisting of bicarbonates, phosphosilicates, pyrophosphates, hexametaphosphates, silicates and mixtures thereof.

6. A coated dental device of claim 1, wherein said ablative abrasive is included in said saliva soluble, base coating.

7. A coated dental device of claim 1, wherein said ablative abrasive is present as an overcoating on said saliva soluble, base coating.

8. A coated dental device of claim 1, wherein said ablative abrasive is present in said saliva soluble, base coating and as an overcoating on said saliva soluble, base coating.

9. A coated dental device of claim 1, wherein said ablative abrasive is calcium sodium phosphosilicate.

10. A coated dental device of claim 9, wherein said calcium sodium phosphosilicate is comprised of: 45% SiO₂, 24.5% Na₂O, 24.5% CaO and 6% P₂O₃.

11. A coated dental device of claim 9, wherein said ablative abrasive is present at between about 0.25% and about 30% by weight of the dental device.

12. A coated dental device of claim 1, wherein said working perception is attributed to the tactile grittiness perceived while winding the device on fingers in preparation for flossing.

13. A coated dental device of claim 1, wherein said working perception is attributed to said ablative abrasive crunchiness perceived during flossing.

14. A coated dental device of claim 13, wherein said ablative abrasive has a working time between about 5 and about 45 seconds.

15. A coated dental device of claim 9, wherein said ablative abrasive has a PWF of at least about 1.

16. A coated dental device of claim 9, wherein said ablative abrasive has an IRF of at least about 70%.

17. A coated dental device of claim 1, wherein said ablative abrasive has an RDA between about 80 and about 200.

18. A coated dental device of claim 1, wherein said ablative abrasive, when exposed to saliva, breaks down.

19. A coated dental device of claim 1, wherein said ablative abrasive, when exposed to saliva, dissolves.

20. A coated dental device of claim 1, wherein said ablative abrasive, when exposed to saliva, ionizes.

21. A coated dental device of claim 1, wherein said ablative abrasive is comprised of granules of at least about 37 microns, wherein said granules are constituted from aggregate particles of water soluble materials below about 37 microns in mean diameter and are perceived as crunchy during flossing.
